(19) United States
(12) Patent Application Publication
(10) Pub. No.: US 2025/0104103 A1
(43) Pub. Date: Mar. 27, 2025

(54) DYNAMIC MODEL SELECTION FOR ACCURATE TIME SERIES FORECASTING

(71) Applicant: NBCUniversal Media, LLC, New York, NY (US)

(72) Inventors: Yong Yi Bay, Waukee, IA (US); Jing Chen, Newton, MA (US)

(21) Appl. No.: 18/475,947

(22) Filed: Sep. 27, 2023

(51) Int. Cl. G06Q 30/0202; G06Q 10/04

(52) U.S. Cl. CPC G06Q 30/0202; G06Q 10/04

(57) ABSTRACT

A forecasting system is designed to train and utilize dynamic models for forecasting metrics associated with content provision. For example, a forecasting system may identify characteristics of received training data relating to a particular title. The characteristics may be used to select one of a plurality of available forecasting models to train.

### BACKGROUND

This disclosure relates generally to improved prediction/forecasting of metrics associated with provided content. More-specifically, forecasting services may dynamically choose a model for prediction/forecasting based upon characteristics of underlying training data associated with the title.

This section is intended to introduce the reader to various aspects of art that may be related to various aspects of the present disclosure, which are described and/or claimed below. This discussion is believed to be helpful in providing the reader with background information to facilitate a better understanding of the various aspects of the present disclosure. Accordingly, it should be understood that these statements are to be read in this light, and not as admissions of prior art.

Content providers (e.g., streaming services) that provide content in exchange for paid subscription fees and/or other revenue sources are becoming increasingly prevalent. To maintain and increase viewership, streaming platforms typically provide increased content offerings of high-quality content. Introduction of new high-quality content can be quite costly and, thus, it is desirable to measure the successfulness of a content title (e.g., a piece of content, a collection of content, such as content series, a current season of a content series, and/or an aggregation of previous seasons of a content series) to maintain existing subscribers and/or capture new subscribers.

In the content provision (e.g., streaming) space, the “inflow” for a given title is defined as its volume of first views among subscribers. “Inflow” constitutes a key metric regarding the success of the title. The ability to monitor and forecast this metric accurately offers enormous business value and competitive advantage to streaming platforms. For example, the inflow measurement may be used to identify the effectiveness of particular titles to draw in and/or retain paid subscribers. As may be appreciated, this may greatly impact business decisions to retain content on the platform, generate new content associated with particular titles, etc. The inflow may be measured at different intervals of time. For example, inflow measurements may be determined over 1 month, 2 months, 6 months, etc. from today or from a user-specified date. The inflow may focus on all users of a content provision platform and/or may target particular users, such as paid subscribers and/or particular paid subscribers (e.g., those on a premium tier and/or a non-premium tier).

While the embodiments described herein focus primarily on inflow forecasting, the described techniques are not limited to improved forecasting of this metric alone. Indeed, with proper tuning, the current techniques may be used to provide improved forecasting of other content provision metrics, such as number of hours watched of a particular title, ad revenue of a particular title (which might include number of ads watched, etc.) and other useful metrics.

In some cases, seasonal trends (e.g., patterns occurring when a time-series is affected by seasonal factors such as time of year, day of week, etc.) may be observed in title popularity and inflow. Time-series methodologies perform well when forecasting titles that have seasonal trends, providing accurate measurements of title popularity and/or inflow. However, even the most state-of-the-art time series methodologies, such as Gradient Boosting Machines (GBMs), become highly erroneous when faced with non-seasonal trends, such as unusually high traffic when a popular title is first aired on the streaming platform. These non-seasonal trends are challenging for time-series methods because the trends do not exhibit the kinds of repeatable patterns that these methods are optimized to learn and forecast. When using traditional time-series methodologies to measure or estimate the inflow of this type of content, the inflow values may not be as accurate as inflow values for seasonal trending titles. This may result in inefficient streaming platform resource utilization. Accordingly, new techniques for measuring title inflow on streaming platforms is desirable.

### BRIEF DESCRIPTION

Certain embodiments commensurate in scope with the originally claimed subject matter are summarized below. These embodiments are not intended to limit the scope of the claimed subject matter, but rather these embodiments are intended only to provide a brief summary of possible forms of the subject matter. Indeed, the subject matter may encompass a variety of forms that may be similar to or different from the embodiments set forth below.

In accordance with an embodiment of the present disclosure, a computing system includes a processor and memory. The memory includes computer-readable instructions that, when executed by the processor, cause the computer system to: receive training data for a forecasting model, the training data specific to a content title; identify, based upon characteristics of the training data, whether or not the content title is associated with a seasonal trend; and select a particular forecasting model for the content title from a plurality of forecasting models, by: when the content title is associated with a seasonal trend, selecting a first forecasting model of the plurality of forecasting models; and when the content title is not associated with a seasonal trend, selecting a second forecasting model of the plurality of forecasting models that is different than the first forecasting model.

In accordance with an embodiment of the present disclosure, a computer-implemented method, includes: receiving training data for a forecasting model, the training data specific to a content title; identifying, based upon characteristics of the training data, whether or not the content title is associated with a seasonal trend; selecting a particular forecasting model for the content title from a plurality of forecasting models, by: when the content title is associated with a seasonal trend, selecting a first forecasting model of the plurality of forecasting models; and when the content title is not associated with a seasonal trend, selecting a second forecasting model of the plurality of forecasting models that is different than the first forecasting model; and training the selected particular forecasting model using the training data.

In accordance with an embodiment of the present disclosure, A content provision metric forecasting system, configured to: forecast a metric associated with provision of a particular content title using a particular forecasting model dynamically selected from a plurality of available forecasting models, by: receiving training data associated with particular content title; selecting the particular forecasting model based upon characteristics of the training data; training the particular forecasting model using the training data; and generating a forecast for the metric using the trained particular forecasting model.

### BRIEF DESCRIPTION OF DRAWINGS

These and other features, aspects, and advantages of the present invention will become better understood when the following detailed description is read with reference to the accompanying drawings in which like characters represent like parts throughout the drawings, wherein:

FIG. 1 is a diagram of a system that uses dynamic time-series model selection for efficient and accurate prediction/forecasting of metrics associated with content provision, in accordance with certain embodiments of the present technique;

FIG. 2 is a diagram, illustrating results of GBM-based prediction/forecasting for titles that are not associated with a seasonal trend, in accordance with certain embodiments of the present technique;

FIG. 3 is a diagram, illustrating results of a GBM-based prediction/forecasting for titles that are associated with a seasonal trend, in accordance with certain embodiments of the present technique; and

FIG. 4 is a flowchart, illustrating a process for dynamic selection of time-series model based upon whether a seasonal trend is identified with respect to a title, in accordance with certain embodiments of the present technique;

FIG. 5 is a flowchart, illustrating a process for identifying seasonal trends with respect to a title, in accordance with certain embodiments of the present technique;

FIG. 6 is a diagram, illustrating an example implementation of the process of FIG. 5, in accordance with certain embodiments of the present technique;

FIG. 7 is a diagram, illustrating enhanced prediction/forecasting results obtained via dynamic time-series model selection, in accordance with certain embodiments of the present technique; and

FIG. 8 is a diagram, illustrating parallel time-series model training for a plurality of titles, in accordance with certain embodiments of the present technique.

### DETAILED DESCRIPTION

One or more specific embodiments will be described below. In an effort to provide a concise description of these embodiments, not all features of an actual implementation are described in the specification. It should be appreciated that in the development of any such actual implementation, as in any engineering or design project, numerous implementation-specific decisions must be made to achieve the developers' specific goals, such as compliance with system-related and business-related constraints, which may vary from one implementation to another. Moreover, it should be appreciated that such a development effort might be complex and time consuming, but would nevertheless be a routine undertaking of design, fabrication, and manufacture for those of ordinary skill having the benefit of this disclosure.

As noted above, there remains a need for improved prediction/forecasting of metrics associated with content provision via a content provision platform. With this in mind, present embodiments are directed to improved prediction/forecasting techniques that use characteristics of a title's underlying training data to select a particular model from a plurality of prediction/forecasting models.

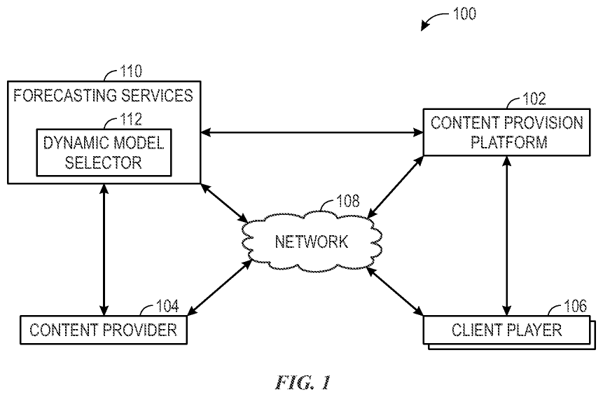

FIG. 1 is a diagram of a system 100 that uses dynamic time-series model selection for efficient and accurate prediction/forecasting of metrics associated with content provision, in accordance with certain embodiments of the present technique. As illustrated, the system 100 includes a content provision platform 102. The content provision platform 102 is an electronic service (e.g., servers) that provide content created and/or supplied by a content provider 104 to client players 106 (e.g., via a network 108, such as the Internet). As mentioned above, it may be desirable to identify metrics associated with the content (e.g., metrics associated with specific titles of the content). For example, the content provision platform 102 and/or the content provider 104 may desire to understand the “success” of a particular title (e.g., how the title impacts revenue of the content provision platform 102 and/or content provider 104). Accordingly, the system 100 includes forecasting services 110, which may intake historical performance data (e.g., from the content provision platform 102) of titles, which may be used as training data to train forecasting models of the forecasting services 110. The forecasting services 110 may forecast metrics associated with titles using the trained models.

There are many options when it comes to time-series methodologies for measuring inflow of content titles. As an example, Gradient Boosting Machines (GBMs) have a strong reputation for providing successful time-series analysis. GBM provides a powerful tree-ensemble technique that combines several weak learners into strong learners, in which each new model is trained to minimize the loss function (such as mean squared error) of the previous model using gradient descent. In each iteration, the algorithm computes the gradient of the loss function with respect to the predictions of the current ensemble and then trains a new weak model to minimize this gradient. The predictions of the new model are then added to the ensemble, and the process is repeated until a stopping criterion is met.

The success of Gradient Boosting Machines (GBMs) lends itself as a-state-of-the-art time-series model for the purposes of forecasting inflow for content titles. Unfortunately, however, as illustrated by the empirical evidence discussed below, GBMs are not good forecasters of inflow for titles that do not experience seasonal trends. In contrast to providing highly accurate forecasted inflow for seasonal titles where viewership changes in line with seasonal offering (e.g., seasonal sports titles), GBMs provide less-accurate forecasted inflows for titles that do not have such seasonal viewership.

Unfortunately, however, as will be illustrated in more detail below, GBM-based forecasting does not lend itself to accurate forecasting for all types of titles. Indeed, as will be shown below, GBM-based forecasting is oftentimes highly inaccurate for titles that are not associated with seasonal trends. Accordingly, as discussed herein, the forecasting services 112 may dynamically switch to another model for titles with seasonal trends.

As illustrated, the forecasting services 110 may include a dynamic model selector 112, which may dynamically select a particular model from a plurality of available models. As mentioned in detail below, the dynamic model selector 112 may select a particular model based upon identified characteristics of the training data. For example, the characteristics of the training data may indicate whether a particular title is associated with seasonal trends. Based upon this indication, a particular model may be selected. This may result in significantly more accurate forecasting of content provision metrics, which may result in better decision making regarding the title (e.g., such as whether to create additional content similar to and/or associated with the title). Upon identifying a forecast for a title, the forecast may be provided in electronic data to a requestor, such as the content provision platform 102 and/or the content provider 104. In some embodiments, the forecast may be provided via a graphical user interface (GUI) (e.g., of the forecasting services 110).

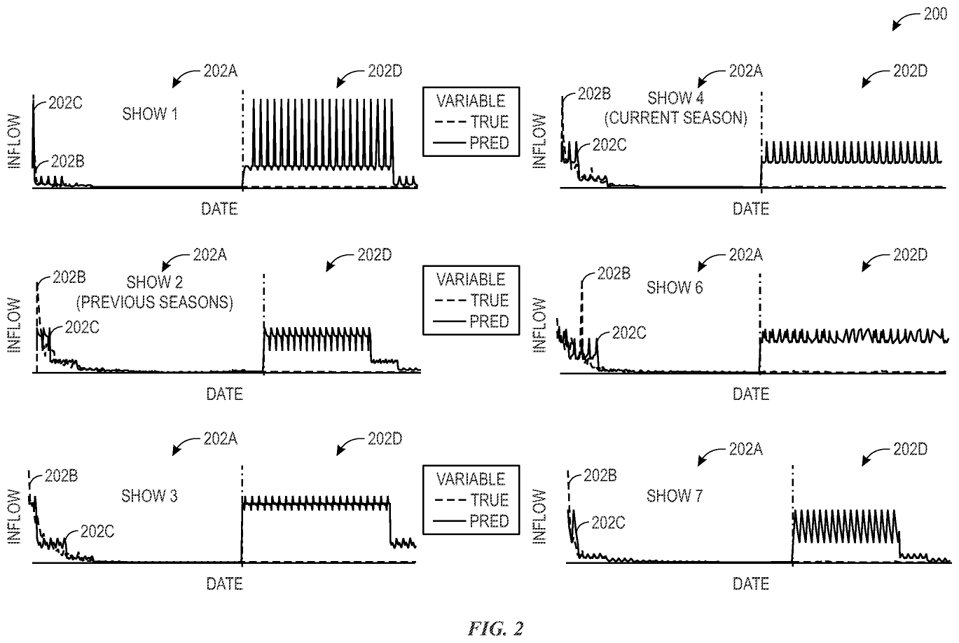

Having discussed the dynamically adjusted forecasting system 100 of FIG. 1, the discussion turns to a more detailed discussion of the time series forecasting models. FIG. 2 is a diagram, illustrating results of GBM-based prediction/forecasting for titles that are not associated with a seasonal trend, in accordance with certain embodiments of the present technique.

FIG. 2 illustrates the results of an experiment that was conducted where historical viewership data was split into training data and evaluation data. An evaluation period of approximately 6 months was set. As used herein, “training data” refers to data that is seen and used by the model for learning, whereas “evaluation data” refers to data that is not seen by the model, but instead is used as known comparison data to sample test set outputs of the model to evaluate the model's performance. Using a GBM model with viewership data of approximately 400 titles having at least 90 days of training data, a performance metric of the cumulative 6-month mean absolute percentage error (MAPE) was ascertained. To calculate the MAPE, the daily actual (A) and daily forecast (F) are summed across the 6-month evaluation period and the % error of 2 numbers

$$\frac{\vert A - F \vert}{A} \times 100$$

is calculated. This metric enables a quantifiable metric of the value of a particular title.

Using this methodology, the results of the experiment illustrate that traditional GMB techniques introduce undesirable error in forecasting title inflow. Overall, the average of the 6-month mean absolute percentage errors (MAPE) across all titles, resulted in significant error.

To dive further into the errors, another perspective was taken, looking at what % of all titles lie in each error bin in the table below. As illustrated, only 23% of the titles have an error of >100%, yet the average 6-month MAPE across all titles was quite large. This indicates that when GBM's forecast is inaccurate, it is highly inaccurate. In other words, a small group of highly inaccurate titles is driving a disproportionate degree of effect in the overall results.

TABLE

| Bins for % 6-month MAPE | % Titles in each error bin |
|---|---|
| <25% error | 22% |
| 25%-50% error | 22% |
| 50%-100% error | 33% |
| >100% error | 23% |

The experiment then focused on the titles with the highest erroneous inflow forecasts. A deep dive into the titles with the highest errors revealed that the largest errors are those illustrated in FIG. 2. In FIG. 2, for each chart, the left side represents a comparison 202A of actual inflows 202B for a particular title to the forecasted inflows 202C for the particular title. The right side of each chart illustrates an evaluation period 202D where the performance of the forecast is assessed.

It is apparent from FIG. 2 that GBM does not perform well on titles that do not have seasonality. These are titles that are very popular when they first aired on the content provision platform 102, but subsequently suffered an exponential decay in terms of its inflow (i.e., fewer paid subscribers join the streaming platform for this title over time). This decay pattern makes sense given the nature of consumer patterns within the streaming industry. However, time-series models do not understand this pattern, instead, continuously propagating the spike seen initially in the actual inflow 202B data to future data points in the forecasted inflows 202C. As illustrated in the evaluation period 202D, this results in highly erroneous forecasts that lead to significant error and can also result in highly defective decision-making if such forecasts were used.

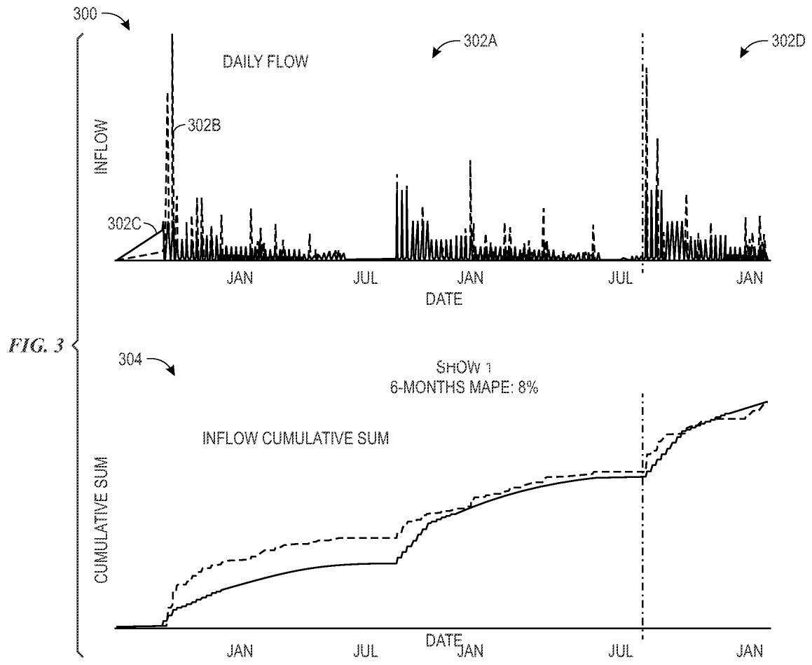

Conceptually, GBM performs poorly in this context because of a lack of seasonality, which is a critical component of time-series methods. To understand time-series modeling better, the experience next examines the case where seasonality exists, and GBM is able to capture the forecasts very accurately. In FIG. 3, example results 300 illustrate this scenario, providing a comparison 302A of actual daily inflow 302B and the forecasted inflow 302C. The right side of the results 300 is the evaluation period 302D where the performance is assessed. As may be appreciated, the title (e.g., Show 1) has a seasonal trend. As illustrated, this title starts its season every August, and slowly declines in daily inflow all the way the next July. This pattern is consistent year over year and makes it easy for the time-series model to learn, and provide appropriate forecasts, achieving a 6-month MAPE of only 8%, as illustrated in MAPE chart 304.

In some embodiments, seasonal trends may not be exclusively temporal-based seasonality. For example, a title of previous seasons of a content series may spike every time a new season of the same content series is released. Thus, the title including the previous seasons of the content series may still include a seasonal trend despite the current seasons being released at differing times. GBM forecasting may still be useful for such a title, assuming the GBM model may predict when such new seasons may be released.

On the other hand, the inflow patterns in FIG. 2, do not repeat, having only a spike at the start, and subsequent decay with time. These non-seasonal trend titles make it extremely difficult for the time-series model to learn and provide accurate forecast.

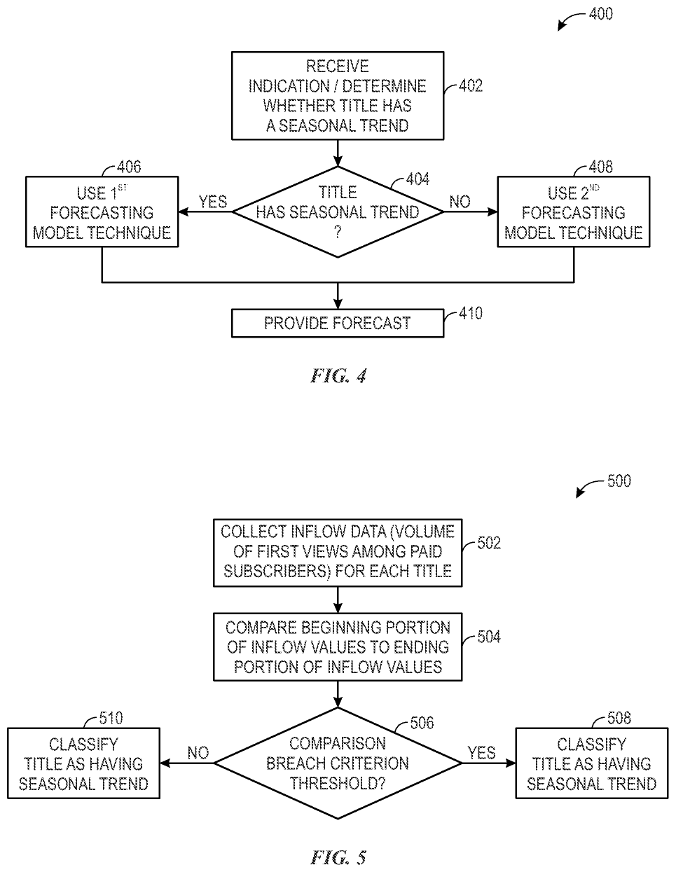

Having discussed the GBM forecasting performance differences between seasonal trend titles and non-seasonal trend titles, the discussion turns to adjustment of forecasting model selection based upon this discovery. FIG. 4 is a flowchart, illustrating a process 400 for dynamic selection of time-series model based upon whether a seasonal trend is identified with respect to a title, in accordance with certain embodiments of the present technique.

The process 400 begins with receiving an indication and/or determining whether a title for forecasting has a seasonal trend (block 402). For example, in certain embodiments, metadata data associated with the title may provide an indication of whether the title is expected to have a seasonal trend. In some embodiments, the seasonal trend indication may be gleaned based upon characteristics of the training data used to train the forecasting models. For example, through extensive research and rigorous tuning, it has become known that a key indicator of titles benefiting from a varied inflow forecasting technique may be identified based upon certain characteristics being found in their training data. In particular, as will be described in more detail below with respect to FIG. 5, a beginning portion of the training data may be compared with an ending portion of the training data to discern an indication of whether the title has a seasonal trend.

At decision block 404, a determination is made as to whether the title is associated with a seasonal trend. If the title is associated with a seasonal trend, a first forecasting model is used (block 406). For example, as described above, a GBM forecasting model may be used to forecast for the title, as the GBM forecasting model is quite good a forecasting for titles having a seasonal trend.

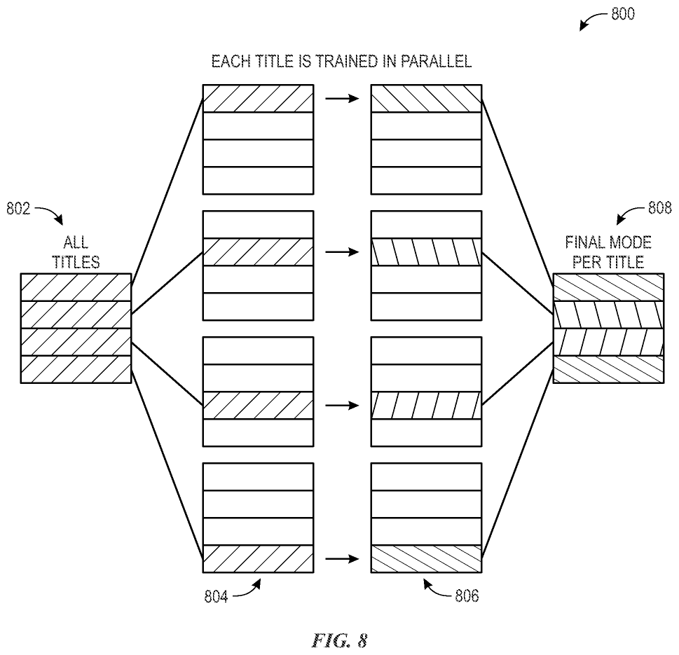

However, if, at decision block 404, the title is determined not to be associated with a seasonal trend, a second forecasting model is used (block 408). For example, a new technique dynamically selecting between Gradient Boosting Machines GBM) and a curve fitting, such as polynomial curve fitting, linear curve fitting, and/or exponential curve fitting (Exp) may provide better forecasting for titles not associated with a seasonal trend. In one embodiment, the technique may dynamically select between GBM and exponential curve fitting (referred to herein as “GBM+Exp”). Exponential curve-fitting (Exp) is the mathematical procedure of finding the best-fitting exponential-curve for a given set of points by minimizing the sum of the squares of distances between the curve and the points. As will be explained in more detail below, the threshold values used to determine if a seasonal trend is associated with the title can be tuned to avoid under-fitting and/or over-fitting in the exponential fitting. Under the GBM+Exp methodology, an exponential fitting is performed for the title, resulting in a smoother curve than that which would be predicted via GBM models. As will be discussed in more detail with respect to FIG. 7, this new GBM+Exp methodology significantly improves forecasting for titles not associated with a seasonal trend.

While the current discussion focuses primarily on combining GBMs with exponential curve fitting, this discussion is not intended to limit the current techniques to use of exponential curve fitting. Indeed, while exponential curve fitting may be used for a wide variety of use cases, other curve fitting models, such as polynomial curve fitting and/or linear curve fitting may be more suitable in other use cases.

Regardless of which forecasting model is used, upon generation of the forecast, the generated forecast may be provided to a requesting entity (block 410). In some embodiments, the forecast is provided via a graphical user interface (GUI) that provides an indication of the generated forecast. In some embodiments, the forecast may be provided via electronic data (e.g., in response to an electronic request for the forecast from a source requestor entity, such as the content provision platform 102 and/or the content provider 104).

Having discussed the overall model selection based upon whether a seasonal trend is associated with the title, FIG. 5 is a flowchart, illustrating a process 500 for identifying seasonal trends with respect to a title, in accordance with certain embodiments of the present technique. As illustrated, the process 500 begins with collecting training data for the title (block 502). For example, because we are forecasting inflow in the current embodiment, inflow data is collected for the title(s) to be forecasted.

At block 504, a beginning portion of the training data is compared to an ending portion of the training data to determine whether the comparison breaches a criterion threshold (decision block 506). For example, in some embodiments, the dynamic model selector 112 may identify such titles when the last days of the training data timeframe have inflow that is approximately 4 times or more lower than the first days of the training data timeframe. When such a pattern is present, the dynamic model selector 112 may classify the title as not having a seasonal trend (block 508), such that an “exponential fit” technique may be chosen to forecast metrics for the title. Conversely, when the comparison does not breach the criterion threshold (e.g., in our current example, the last days are not approximately 4 times or more lower than the first days), the title is classified as having a seasonal trend (block 510), such that a non-Exp forecasting technique may be used.

The beginning portion and ending portion may be set to a specific beginning percentage and ending percentage of the training data, respectively. In this manner, as the training data increases, the beginning portion and ending portion may also increase, resulting in increasingly accurate results. In some embodiments, the beginning portion may be set to an aggregation (e.g., a mean) of the first 10% of the training data and the ending portion may be set to an aggregation (e.g., a mean) of the last 10% of the training data. The range of the beginning and ending portions along with the comparison threshold may be tuned for specific use cases/metrics to be forecasted. For example, with respect to forecasting inflow, after extensive experimentation and tuning, it has been observed that setting the beginning portion to the mean of the first 10% of the training data, the ending portion to the mean of the last 10% of the training data, and the comparison threshold to indicate that the ending portion is approximately 4 times lower or more than the beginning portion, provides much improved accuracy. Different portion ranges and/or comparison ranges could be tuned for other use cases, such as forecasted viewership (e.g., number of users that completed viewing of the title) or other metrics.

For titles with non-temporal seasonal trends, such as titles that experience spikes when current seasons are released, the beginning portions and ending portions may change. For example, these portions may be set such that these portions coincide with the release dates of the then current seasons. This may result in comparable data between beginning and ending portions that coincide with the release of a new season, to identify if such seasonality exists.

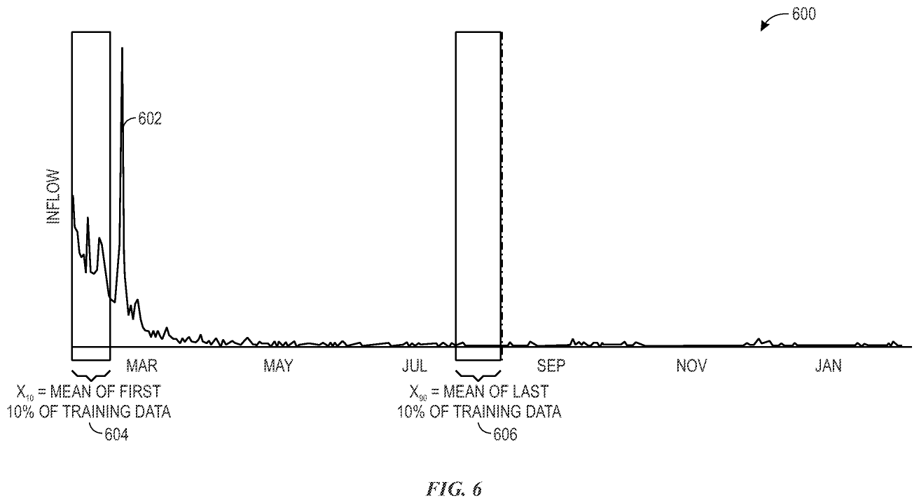

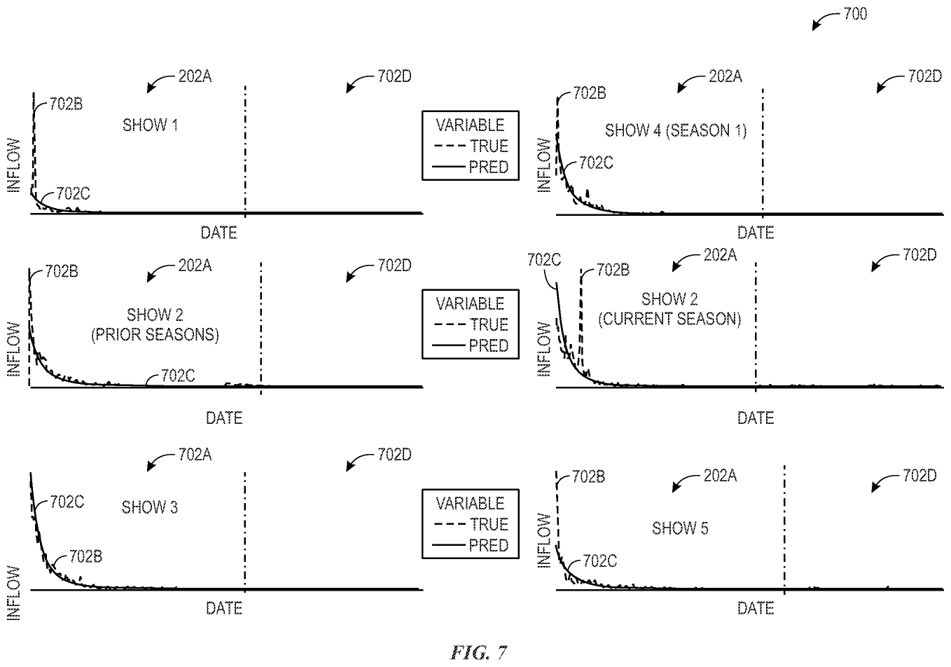

FIG. 6 is a diagram, illustrating an example implementation 600 of the portion selection in accordance with the example described above with respect to process 500 of FIG. 5, in accordance with certain embodiments of the present technique. As illustrated, training data 602 for a particular title is supplied. As mentioned above, in the current example, the beginning portion 604 is identified as the mean of the first 10% of the training data (here denoted as x₁₀). The ending portion 606 is identified as the mean of the last 10% of the training data (here denoted as x₉₀). When x₁₀/x₉₀>4, the title is classified as not being associated with a seasonal trend and, thus, exponential fitting is implemented for forecasting purposes.

As mentioned above, the criterion threshold (e.g., here 4) can be manually tuned to prevent over-fitting and/or under-fitting. For the purposes of forecasting inflow, rigorous manual tuning was conducted to ensure that a proper criterion threshold of 4 was used, such that only the right titles were marked as “Exponential Fit” patterns given the criterion threshold.

FIG. 7 is a diagram, illustrating enhanced prediction/forecasting results 700 obtained via dynamic time-series model selection, in accordance with certain embodiments of the present technique. As illustrated, the actual inflow 702B does not show seasonal spikes in inflow. The forecasted inflow 702C is a smoothed curve that is exponentially fitted to the training data. The evaluation period 702D illustrates a significant improvement in inflow forecasting, based upon the forecasted inflow 702C more closely following the actual inflow 702B.

Indeed, by extending the new methodology of Gradient Boosting Machines+Exponential Fitting (GBM+Exp), dynamically choosing between GBM and a curve fitting (Exp) based upon seasonality, to all titles, a vast forecasting improvement was observed among titles that had >100% error when using just the time-series model GBM. Indeed, all titles improved, with many of them improving their forecasts by more than 300×. This improvement is attributed to the new methodology described herein, where titles that benefit from exponential fitting are accurately identified and addressed appropriately.

The table below provide a contrast between a traditional GBM methodology and the new GBM+Exp methodology.

| | |
|---|---|
| Bins for % 6-month mean | % Titles in each error bin |

| absolute % error (MAPE) | GBM | GBM + Exp |
|---|---|---|
| <25% error | 22% | 28% |
| 25%-50% error | 22% | 29% |
| 50%-100% error | 33% | 38% |
| >100% error | 23% | 5% |

As may be appreciated, the forecasting with an absolute % error (MAPE) of >100% decreased from 23% to 5%, resulting in significantly less forecasting error. Indeed, in the experiment, the GBM+Exp methodology resulted in forecasting that was 8.7× more accurate than the GBM methodology.

FIG. 8 is a diagram, illustrating parallel time-series model training for a plurality of titles, in accordance with certain embodiments of the present technique. As illustrated, forecasting model training may occur in parallel for each title or a subset of titles. The list of titles 802 to forecast for is submitted. Training data 804 for each model is submitted for training, resulting in trained models 806 for each title. In some embodiments, each trained model 806 may be aggregated into an aggregated final model per title 808, enabling forecasting across all titles in the list 802 via a single model (final model 808).

Parallel processing of the training per title may provide significant time savings. For example, in a cloud-based implementation using a compute engine with 112 CPUs/224 GB RAM, a parallel implementation of forecast training per title took approximately 1.5 minutes for 400 titles. In contrast, in a sequential training implementation, the forecast training took approximately 45 minutes for the same 400 titles. Thus, the parallel forecast training is quite scalable and is able to train models 30× faster than sequential training implementations.

The technical effects of the present disclosure include a prediction/forecasting service that dynamically selects a prediction/forecasting model based upon characteristics of the underlying training data. Specifically, characteristics of the training data may indicate whether or not a title is associated with seasonal trend. A corresponding model may be selected for a particular title, based upon in indication of whether or not the title is associated with a seasonal trend. This enables vast improvement in the forecasting system, by enabling the forecasting system to select, based upon the training data, an accurate model for prediction/forecasting, enabling the forecasting system to generate accurate and efficient forecasts based upon the training data without reliance on human subjectivity.

While only certain features of the invention have been illustrated and described herein, many modifications and changes will occur to those skilled in the art. It is, therefore, to be understood that the appended claims are intended to cover all such modifications and changes as fall within the true spirit of the invention.

The techniques presented and claimed herein are referenced and applied to material objects and concrete examples of a practical nature that demonstrably improve the present technical field and, as such, are not abstract, intangible or purely theoretical. Further, if any claims appended to the end of this specification contain one or more elements designated as “means for (perform)ing (a function) . . . ” or “step for (perform)ing (a function) . . . ”, it is intended that such elements are to be interpreted under 35 U.S.C. 112 (f). However, for any claims containing elements designated in any other manner, it is intended that such elements are not to be interpreted under 35 U.S.C. 112 (f).

1. A computing system, comprising:
a processor; and
memory comprising computer-readable instructions that, when executed by the processor, cause the computer system to:
receive training data for a forecasting model, the training data specific to a content title;
identify, based upon characteristics of the training data, whether or not the content title is associated with a seasonal trend;
select a particular forecasting model for the content title from a plurality of forecasting models, by:
when the content title is associated with a seasonal trend, selecting a first forecasting model of the plurality of forecasting models; and
when the content title is not associated with a seasonal trend, selecting a second forecasting model of the plurality of forecasting models that is different than the first forecasting model; and
forecast a metric associated with the content title based on the selected particular forecasting model.

2. The computing system of claim 1, wherein the memory comprises computer-readable instructions that, when executed by the processor, cause the computer system to train the selected particular forecasting model using the training data.

3. The computing system of claim 2, wherein the memory comprises computer-readable instructions that, when executed by the processor, cause the computer system to train the selected particular forecasting model using the training data in parallel with training of a second particular forecasting model using second training data of a second content title.

4. The computing system of claim 1, wherein the first forecasting model comprises a Gradient Boosting Machine (GBM) based model.

5. The computing system of claim 1, wherein the second forecasting model comprises an Exponential curve-fitting (Exp) based model.

6. The computing system of claim 1, wherein the memory comprises computer-readable instructions that, when executed by the processor, cause the computer system to identify whether or not the content title is associated with a seasonal trend, by:
identifying a beginning portion of the training data;
identifying an ending portion of the training data;
comparing the beginning portion of the training data to the ending portion of the training data; and
determining whether or not the content title is associated with a seasonal trend based upon the comparison.

7. The computing system of claim 6, wherein the memory comprises computer-readable instructions that, when executed by the processor, cause the computer system to:
compare the beginning portion of the training data to the ending portion of the training data, by:
identifying a mean of the beginning portion of the training data;
identifying a mean of the ending portion of the training data; and
determining whether a ratio of the mean of the beginning portion of the training data to the mean of the ending portion of the training data meets or breaches a criterion threshold; and
determine whether the content title is associated with a seasonal trend based upon whether the criterion threshold is met or breached by the ratio.

8. The computing system of claim 7, wherein the metric comprises an inflow of the content title.

9. The computing system of claim 8, wherein:
the beginning portion of the training data comprises a temporal first 10% of the training data;
the ending portion of the training data comprises a temporal ending 10% of the training data; and
the criterion threshold comprises approximately 4.

10. The computing system of claim 8, wherein the inflow is specific to paid subscribers of a content provision platform of the content title, a particular tier of paid subscribers, or both.

11. The computing system of claim 1, wherein the content title comprises a collection of digital content, the collection of digital content comprising a current season of a content series, an aggregation of previous seasons of the content series, or both.

12. A computer-implemented method, comprising:
receiving training data for a forecasting model, the training data specific to a content title;
identifying, based upon characteristics of the training data, whether or not the content title is associated with a seasonal trend;
selecting a particular forecasting model for the content title from a plurality of forecasting models, by:
when the content title is associated with a seasonal trend, selecting a first forecasting model of the plurality of forecasting models; and
when the content title is not associated with a seasonal trend, selecting a second forecasting model of the plurality of forecasting models that is different than the first forecasting model; and
training the selected particular forecasting model using the training data; and
forecasting a metric associated with the content title based on the selected particular forecasting model.

13. The computer-implemented method of claim 12, comprising training the selected particular forecasting model using the training data in parallel with training of a second particular forecasting models using second training data of a second content title.

14. The computer-implemented method of claim 12, wherein:
the first forecasting model comprises a Gradient Boosting Machine (GBM) based model; and
the second forecasting models comprises an Exponential curve-fitting (Exp) based model.

15. The computer-implemented method of claim 12, comprising identifying whether or not the content title is associated with a seasonal trend, by:
identifying a mean of a beginning portion of the training data;
identifying a mean of an ending portion of the training data;
comparing the mean of the beginning portion of the training data to the mean of the ending portion of the training data; and
determining whether or not the content title is associated with a seasonal trend based upon the comparing.

16. The computer-implemented method of claim 15, comprising:
comparing the mean of the beginning portion of the training data to the mean of the ending portion of the training data, by:
determining whether a ratio of the mean of the beginning portion of the training data to the mean of the ending portion of the training data meets or breaches a criterion threshold; and
determining whether or not the content title is associated with a seasonal trend based upon whether or not the criterion threshold is met or breached by the ratio.

17. The computer-implemented method of claim 16, wherein:
the metric comprises an inflow of the content title;
the beginning portion of the training data comprises a temporal first 10% of the training data;
the ending portion of the training data comprises a temporal ending 10% of the training data; and
the criterion threshold comprises approximately 4.

18. A content provision metric forecasting system, configured to:
forecast a metric associated with provision of a particular content title using a particular forecasting model dynamically selected from a plurality of available forecasting models, by:
receiving training data associated with particular content title;
selecting the particular forecasting model based upon characteristics of the training data;
training the particular forecasting model using the training data; and
generating a forecast for the metric using the trained particular forecasting model.

19. The content provision metric forecasting system of claim 18, configured to:
select the particular forecasting model, by:
identifying a mean of a beginning portion of the training data;
identifying a mean of a ending portion of the training data;
determining whether a ratio of the mean of the beginning portion of the training data to the mean of the ending portion of the training data meets or breaches a criterion threshold;
determining whether or not the content title is associated with a seasonal trend based upon whether or not the criterion threshold is met or breached by the ratio;
when the content title is associated with a seasonal trend, select a Gradient Boosting Machine (GBM) based model as the particular forecasting model; and
when the content title is not associated with a seasonal trend, select an Exponential curve-fitting (Exp) based model as the particular forecasting model.

20. The content provision metric forecasting system of claim 19, wherein:
the metric comprises an inflow of the content title; and
the criterion threshold comprises a value of approximately 4.
